(19) United States
(12) Patent Application Publication
(10) Pub. No.: US 2024/0201515 A1
(43) Pub. Date: Jun. 20, 2024

(54) ADJUSTABLE ELECTRONIC DEVICE

(71) Applicant: Apple Inc., Cupertino, CA (US)

(72) Inventor: Paul X. Wang, Cupertino, CA (US)

(21) Appl. No.: 18/593,934

(22) Filed: Mar. 3, 2024

Related U.S. Application Data
(63) Continuation of application No. PCT/US2022/076218, filed on Sep. 9, 2022.
(60) Provisional application No. 63/261,195, filed on Sep. 14, 2021.

(51) Int. Cl. G02C 5/14; G06F 1/16

(52) U.S. Cl. CPC G02C 5/143; G06F 1/163

(57) ABSTRACT

A wearable electronic device including a display and a support arm attached to the display. The support arm can define a sleeve and can include an extendable portion movable within the sleeve. The support arm having a retracted state and an extended state.

### CROSS-REFERENCE TO RELATED APPLICATION(S)

This is a continuation of International Patent Application No. PCT/US2022,076218, filed 9 Sep. 2022, entitled “ADJUSTABLE ELECTRONIC DEVICE,” which claims priority to U.S. Provisional Patent Application No. 63/261,195, filed 14 Sep. 2021, entitled “ADJUSTABLE ELECTRONIC DEVICE,” the entire disclosure of which is hereby incorporated by reference.

### FIELD

The described embodiments relate generally to wearable electronic devices. More particularly, the present embodiments relate to configurable arm tips for head-mounted devices, including smart or computer glasses.

### BACKGROUND

Head-mounted devices, such as computer glasses or smart glasses, are worn on a user's head and incorporate an optical display and computing capabilities. Computer glasses are typically supported on the user's head by support arms that are connected to either side of the glasses. With the advent of computer glasses comes an increased demand on the support arms to support the increased weight and movement of the computer glasses. Further, the inclusion of sensitive electronic components enhances the need to prevent drop events that could damage the sensitive components.

Further, head-mounted devices include electrical components, such as speakers and cameras, whose positioning needs to accommodate for a wide variety of variances in users (e.g., facial features, head shape, ear position, and head tilt) and environments.

### SUMMARY

According to some aspects of the present disclosure, a wearable electronic device includes a display and a support arm attached to the display. The support arm defining a sleeve and including an extendable portion movable within the sleeve. The support arm having a retracted state and an extended state. Additionally, the wearable electronic device can include an inertial measurement unit (IMU) attached to the wearable electronic device, and an actuator connected to the extendable portion. The actuator can transition the extendable portion from the retracted state to the extended state in response to a signal received by the actuator from the IMU.

In some examples, the support arm is a first support arm, the extendable portion is a first extendable portion, and the actuator is a first actuator. The wearable electronic device can include a second support arm attached to the display, the second support arm including a second extendable portion and a second actuator connected to the second extendible portion. In some examples, a distance between the first extendable portion and the second extendable portion is greater in the retracted state than in the extended state. The IMU can generate the signal in response to a detected motion.

In some examples, the actuator can be a mechanical actuator engaged with the extendible portion. The extendable portion can define a radius of curvature in the extended state. The support arm can define a pressurized chamber adjacent to the extendible portion. The actuator can cause the pressurized chamber to exert a force on the extendable portion in response to the signal.

In some examples, the extendable portion includes a mass portion and the extendable portion moves in response to a change in an orientation of the wearable electronic device relative to a gravitational vector. The wearable electronic device can include a sensor configured to detect a removal of the wearable electronic device. A proximal end of the support arm can be connected to the display, and the extendable portion can be located at a distal end of the support arm. The extendable portion can be bi-stable. The wearable electronic device can include a camera configured to determine a position of the wearable electronic device relative to a head of a user.

According to some aspects, a support arm includes a static section and a movable section connected to the static section. The movable section can dynamically vary a length of the support arm. The support arm can further include an inertial measurement unit (IMU), and the movable section can extend in response to a signal from the IMU.

In some examples, the IMU is configured to generate the signal in response to detecting a motion of the support arm. The support arm can include a mechanical actuator connected to the movable section. The support arm can include an electrical actuator connected to the movable section. The static section can define an internal volume configured to receive the movable section.

According to some aspects, a wearable electronic device can include a display, and a support arm attached to the display. The support arm can define a sleeve and can include an extendable portion that is movable within the sleeve, the support arm having a retracted state and an extended state. The support arm can further define a pressurized chamber adjacent to the extendible portion, wherein the pressurized chamber exerts a force on the extendable portion in response to a detected motion.

In some examples, the wearable electronic device includes a camera, an actuator connected to the pressurized chamber, and an inertial measurement unit (IMU) connected to the actuator. The IMU can transmit a signal to the actuator when a motion is detected, and the actuator can cause the pressurized chamber to exert the force in response to the signal. The camera can be configured to determine an orientation of the wearable electronic device relative to a head of a user.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a side view of computer glasses.

FIG. 1B shows a side view of computer glasses in an extended state.

FIG. 2A shows a side view of computer glasses in a retracted state.

FIG. 2B shows a side view of the computer glasses of FIG. 2A in an extended state.

FIG. 3A shows a cross-sectional side view of a support arm in a retracted state.

FIG. 3B shows a cross-sectional side view of the support arm of FIG. 3A in an extended state.

FIG. 4 shows a cross-sectional side view of a support arm in an extended state.

FIG. 5 shows a top view of computer glasses with adjustment features.

FIG. 6A shows a cross-sectional top view of a support arm in a retracted position.

FIG. 6B shows a cross-sectional top view of a support arm in an extended position.

FIG. 7 shows a perspective side view of a head-mounted device.

FIG. 8A shows a side view of a head-mounted device.

FIG. 8B shows a side view of an articulable camera unit.

FIG. 8C shows a side view of a customized camera unit.

### DETAILED DESCRIPTION

Detailed reference will now be made to representative examples illustrated in the accompanying drawings. It should be understood that the following descriptions are not intended to limit the embodiments to one preferred embodiment. Rather, it is intended to cover alternatives, modifications, and equivalents as can be included within the spirit and scope of the described embodiments as defined by the appended claims.

Headwear, such as head-mounted devices (including computer glasses) should accommodate for various head shapes and sizes. Support arms for computer glasses typically include a robust structure to encase electronics in small form factors, making typical adjustability found in traditional spectacles unfeasible. Furthermore, computer glasses necessitate a more controlled and accurate fit than traditional spectacles due to the need to align the display eye box to the user, and often incorporate clever retention mechanisms due to the heavy weight of the computer glasses. The present disclosure is directed, in part, to computer glasses that incorporate extendable support arm tips. The present disclosure further describes customized electrical components, such as speakers and cameras, individually tailored to the user.

In some examples, a wearable electronic device, such as computer glasses (also referred to as “smart glasses,” “head-mounted device,” or simply “glasses”) includes lenses positioned in front of the user's eyes. The lenses can be integrated with a display unit to display visual information to the user. The lenses and display unit can be supported on the user's head by a securement mechanisms, such as a strap or a band wrapping around the user's head, or support arms positioned on opposing sides of the lenses and configured to rest on or above the user's ears.

In some examples, each support arm includes a static portion. The static portion can be rigid and can generally maintain its overall shape and configuration. In some examples, the static portion defines an internal volume that houses electrical components. The support arm can further include an arm tip having an adjustment mechanism. The adjustment mechanism can be movable relative to the static portion of the support arm. The adjustment mechanism can shape or reconfigure the support arm in order to better secure the glasses to the user's head. For example, the adjustment mechanism can include an extendable portion that extends out of an end of the support arm and is configured to at least partially wrap around a user's ear and/or head. In some examples, both support arms of the glasses can include an adjustment mechanism. While in other examples, only one of the support arms includes the adjustment mechanism.

The adjustment mechanism can be located at the distal end of the support arm (i.e., opposite the end coupled to the lenses/display). By being positioned at the distal end of the support arm, the adjustment mechanism can partially wrap around the ears or back of the head of the user.

In some examples, the adjustment mechanism is gravity driven. For example, an arm tip can dynamically extend from the support arm solely or partially in response to a change in an orientation of the HMD relative to a gravitational vector. In some examples, the extension of the arm tip occurs only due to gravitational forces (i.e., no other motor or actuators are needed to extend the arm tip. In some examples, the adjustment mechanism includes a mechanical actuator to control the motion of the adjustment mechanism. For example, the mechanical actuator can include one or more of a knob, a dial, a screw, a cam, or any other suitable mechanical actuator. In some examples, the adjustment mechanism includes an electrical actuator to control motion of the adjustment mechanism. For example, the electrical actuator can include one or more of an electrical motor, a piezoelectric motor, a solenoid, an electromagnet, or any other suitable electrical actuator. As described herein, the adjustment mechanism can include a wide variety of components and features.

The adjustment mechanism can controllably enable the arm tip to be in an extended configuration or a retracted configuration. In the extended configuration, an overall length of the support arm is increased from when in the retracted configuration. In some examples, the support arm and the arm tip can define a radius of curvature when in the extended position such that the arm and arm tip can then further secure the computer glasses on the user.

There are a variety of ways that the adjustment mechanism can transition between the retracted state and the extended state. In some examples, user input can activate the transition between states. For example, a user can manually actuate the adjustment mechanism to transition to the extended state by applying a force (e.g., pushing, pressing, rotating, sliding, etc.).

In some examples, an electrical signal can actuate a transition between the retracted and extended states. The signal can be transmitting in response to user input or can occur automatically upon predetermined conditions being met. In some examples, the adjustment mechanism transitions between states in response to receiving a signal from one or more sensors on the computer glasses. For example, the computer glasses can include an inertial measurement unit (IMU) that detects motion. The adjustment mechanism can activate in response to the IMU detecting motion exceeding a predetermined threshold. In some examples, the computer glasses can include a sensor to detect when the computer glasses are place on a user's head, and the adjustment mechanism can be activated in response to detecting that the user has donned the glasses. In some examples, the act of removing the computing glasses from the user's head naturally actuates the adjustment mechanism to return to the retracted state. In some examples, one or more sensors can determine whether a user intends to remove the computer glasses, and in response, the activation mechanism is not activated in response to detection motion of the computer glasses.

With further reference to speakers incorporated with HMD devices, the performance of a speaker can depend, at least in part, on the position the speaker relative to certain anatomical features of the user. For example, the performance of a speaker of the HMD can be based on the position of the speaker relative to the user's ears. This can be especially true when the speakers are used to create a spatial audio experience as described above.

In some examples, a speaker can be integrated with or on a securement strap of the HMD such that the speaker is positioned close to the user's ear. In such an example, the speaker can be configured to emanate sound in a primary direction towards the user's ear. In some examples, multiple speakers can be positioned and directed toward both ears of the user.

One difficulty in ensuring a proper placement of the speakers of the HMD relative to the user's ears is the anatomical differences between users. Head sizes vary and the distance between a user's ears and other anatomical features, for example the nose or brow where the display portion of the HMD may rest, varies between users. Even on a single user, the distance between the nose or cheekbones and the user's left ear can be different from the distance to the right ear. These anatomical variations make it difficult to manufacture a one-size-fits-all HMD device that would perform the same for all users. In addition, inconsistent donning of HMD devices can result in slightly different positioning of speakers or other electronic components of the HMD anytime the user dons the device.

Accordingly, the HMD can include components that can be adjusted to adapt to inconsistent anatomical features of different users and variations associated with inconsistent donning. Such components can also be adjusted depending on the general position, location, and orientation of the user during use. In this way, components such as speakers, cameras, and other components can be optimally configured for enhanced performance. In some examples, components such as speakers of HMDs described herein can be automatically or manually adjusted or repositioned along a securement mechanism, such as a band, strap, or support arm that secures the HMD to the user's head, at the appropriate position and/or in the appropriate orientation. In some examples, components such as cameras of HMDs described herein can be automatically or manually adjusted or repositioned on a frame or display unit of the HMD, at the appropriate position and/or in the appropriate orientation.

In some examples, one or more components (e.g. speakers, cameras) of an HMD can be secured to the HMD via one or more position adjusting mechanisms. In some examples, once the user has donned the HMD, the components can be moved to reposition or reorient the components based on one or more user characteristics, such as head tilt or ear position. In some examples, the repositioning or adjustment of the components can be accomplished manually. In some examples, the repositioning or adjustment of the components can be accomplished automatically or dynamically using one or more automatic repositioning drive mechanisms of the HMD. In the examples where adjustments are done manually, certain guides or physical datum surfaces, which indicate to the user when the speaker is correctly positioned, can be provided.

Additionally, or alternatively, one or more sensors can be integrated with the HMD and feedback can be given as the user manually adjusts the components to indicate when an optimal position or orientation has been achieved. Such feedback can be given visually through the HMD display portion or tactilely, audibly, or otherwise using the display portion or one or more other modules or components of the HMD. In examples where speaker adjustments are done automatically by the HMD, the one or more sensors, either sensors directly coupled with the speakers or disposed elsewhere on the HMD, can be used to determine where and how each speaker should be positioned relative to the user's ears.

In examples where camera adjustments are done automatically by the HMD, the one or more sensors, either sensors directly coupled with the cameras or disposed elsewhere on the HMD, can be used to determine where and how each camera should be positioned based on a field of view of each camera.

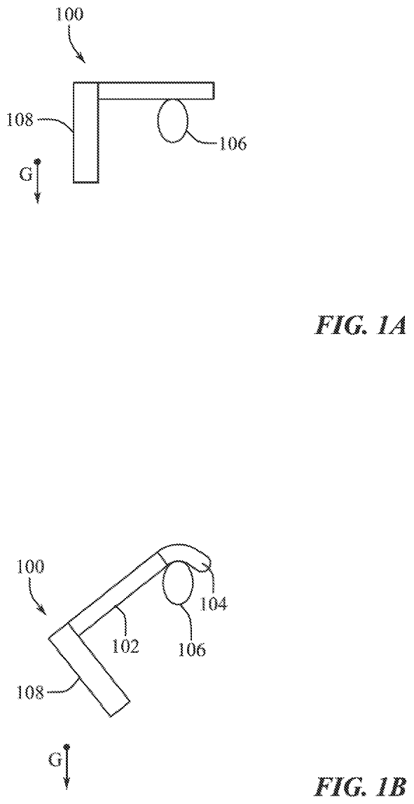

These and other embodiments are discussed below with reference to FIGS. 1-8C. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1A shows a side view of computer glasses 100. FIG. 1A shows the user's head in a substantially upright position (i.e., an axis from the top to the bottom of the head is substantially parallel with a gravitational vector G, while an axis from the back of the head to the face is substantially perpendicular to the gravitational vector G). While many of the embodiments depicted herein show computer glasses, it will be understood that the concepts can apply to various types of head-mounted devices.

The computer glasses 100 can include a display element 108 that is positioned in front of the eyes of a user to provide visual information within a field of view of the user. The display element 108 can transmit light from a physical environment. The display element 108 can include optical properties, such as lenses for vision correction based on incoming light from the physical environment. Additionally or alternatively, the display element 108 can display information within a field of view of the user. The information can be provided to the exclusion of a view of a physical environment or in addition to (i.e., overlaid with) a physical environment.

In some examples, the computer glasses 100 include one or more support arms 102 that support the computer glasses 100 on an object 106. The object 106 can be an ear of the user. The support arm 102 can be coupled to, and extending from, the edges of the computer glasses 100. The support arm 102 can house internal electronic components. For example, the support arm 102 can enclose and support various integrated circuits, chips, processors, memory devices and other electronic elements to provide computing and functional operations for the computer glasses 100. The support arm 102 can wrap or extend along opposing sides of the user's head, as with a temple component.

FIG. 1B shows the computer glasses 100 tilting downward (i.e., with the display 108 tilting toward the direction of the gravitational vector G). In some examples, the computer glasses 100 include an extendable ear hook or arm tip 104 that is extendable from the support arm 102. The arm tip 104 can be configured to partially wrap around or otherwise engage a user's ears and/or head. As discussed in greater detail herein, the arm tip 104 can assume a retracted position within the support arm 102 or an extended position. Actuation of the arm tip 104 can results in a wide variety of ways, some of which are described herein.

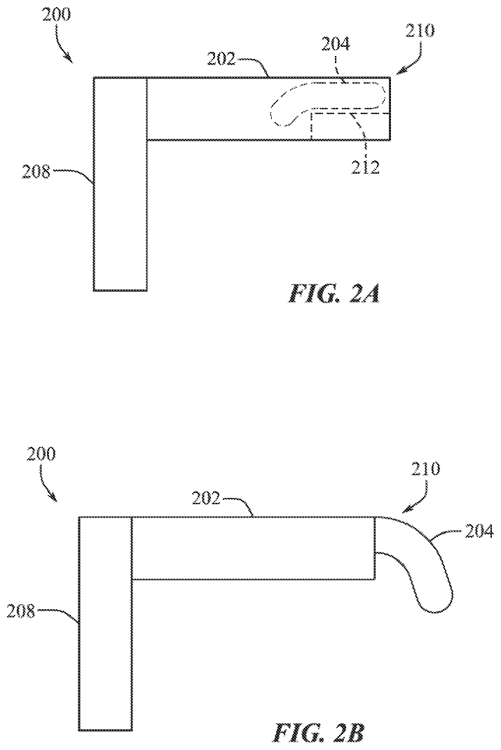

FIG. 2A shows a side view of computer glasses 200. The computer glasses 200 can be substantially similar to, including some or all of the features of, the computer glasses described herein, such as the computer glasses 100. The computer glasses can include a support arm 202 positionable along the side of the user's head and over the ear. The support arm 202 can define an internal volume or sleeve. An arm tip 204 can be at least partially housed within the internal volume of the support arm 202. In some examples, the arm tip 204 is positioned externally adjacent to the support arm 202 in the retracted position. The arm tip 204 can be positioned externally along a top, bottom, or side of the support arm 202. In some examples, electrical components are housed within the internal volume of the arm tip 204.

In some examples, a majority of the arm tip 204 is positioned within the support arm 202 when in the retracted position. In some examples, in the extended configuration, the arm tip 204 is partially or completely pulled out of the internal volume of the support arm 202, such that a portion of the arm tip 204 is not housed or contained within the support arm 202.

The arm tip 204 can be operatively coupled to an actuator configured to dynamically move the arm tip 204 from a retracted state (i.e., a state in which a substantial portion of the arm tip 204 is housed with the support arm 202, as shown in FIG. 2A) to an extended state (i.e., a state in which a portion of the arm tip 204 is withdrawn from the support arm 202, as shown in FIG. 2B. In some examples, the arm tip 204 can improve the fit and securement of the support arm 202 on a head of a user, especially while the user is moving or looking downward. Specifically, the arm tip 204 can wrap around or contact the user's ear/head to better secure the computer glasses 200 and prevent slippage.

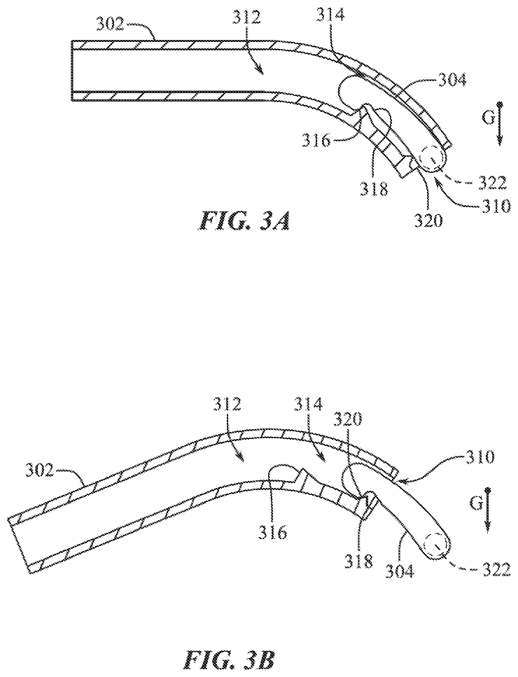

The support arm 202 can include a protrusion, ledge, shelf, protrusion or other variation 212 in the shape of the support arm 202. The protrusion 212 can correspond to a shape of the arm tip 204. In some examples, the protrusion 212 allows the arm tip 204 to fit within the support arm 202. In some examples, the arm tip 204 is curved to cause the arm tip 204 to extend downward as well as backward from the support arm 202. In some examples, the curvature of the arm tip 204 is configured to wrap behind a user's ear and further secure the computer glasses 200 to the head of the user. In this manner, the support arm 202 and the arm tip 204 can define a radius of curvature when in the extended state. Further details regarding the movement of the arm tip is provided below with references to FIGS. 3A and 3B.

FIG. 3A shows a cross-sectional side view of a support arm 302 in a retracted position. FIG. 3B shows a cross-sectional side view of the support arm 302 in an extended position. The support arm 302 can be substantially similar to, including some or all of the features of, the support arms described herein, such as the support arm 102 and 202. The support arm 302 can define an interior volume or sleeve 312. An arm tip 304 can be at least partially disposed within the sleeve 312. In some examples, the arm tip 304 can be configured to extend out of the sleeve 312 through an aperture 310 in an end of the support arm 302.

In some examples, the arm tip 304 extends out of the aperture 310 in response to a change in the orientation of the support arm 302 relative to a gravitational vector G. Extension of the arm tip 304 can be partially or entirely gravity driven. In other words, the arm tip 304 can be configured to extend out of the support arm 302 primarily in response to a change in the gravitational vector G relative to the support arm 302.

In some examples, the arm tip 304 includes a notch or depression 318. An interior surface of the support arm 302 can define a tab configured to couple with the notch 318 to prevent the arm tip 304 from sliding out of the support arm 302. Further, the arm tip 304 can include a mass portion 322 located at an end of the arm tip 302. The mass portion 322 can be the heaviest portion of the arm tip 304, such that a center of mass of the arm tip 304 is located proximate the end of the arm tip with the mass portion 322. In some examples, the arm tip 304 can contact a fulcrum 320. The arm tip 304 can be supported and partially balanced on the fulcrum 320. As the support arm 302 is tilted (e.g., when the user looks down), the arm tip 304 pivots on the fulcrum such that the notch 318 detaches or slides off the tab 316. In some examples, a gap 314 exists between the arm tip 304 and the interior surface of the support arm 302. The gap 314 can provide space for the arm tip 304 to pivot within the support arm 302.

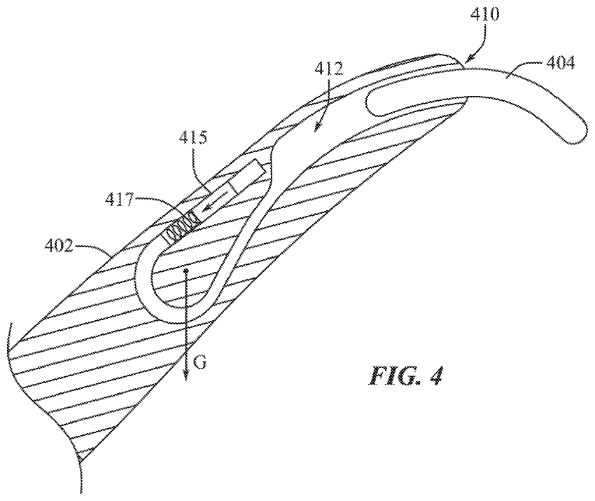

As shown in FIG. 3B, upon tilting the support arm 302, the arm tip 304 can pivot about the fulcrum 320 and release from the tab 316. The arm tip 304 can then freely slide out of the aperture 310 to extend around the user's ear and/or head. In some examples, the aperture 310 is smaller than an end of the arm tip 304 to prevent the arm tip 304 from falling out of the sleeve 312. In some examples, the notch 318 is configured to engage with the fulcrum 320 in the extended position. The arm tip 304 can be configured to be pushed back into the retracted position within the support arm 302. Alternatively, the arm tip 304 can be spring loaded or otherwise configured to be a bi-stable system that dynamically changes its position based on a detected tilt and/or gravitational orientation. Additionally, the arm tip can include an actuator that releases the arm tip 304 in response to a signal from a sensor, such as an IMU. Further details of example adjustment mechanisms are provided below with reference to FIG. 4.

FIG. 4 shows a cross-sectional side view of a support arm 402. The support arm 402 can be substantially similar to, including some or all of the features of, the support arms described herein, such as the support arm 102, 202, and 302. An arm tip 404 can be at least partially disposed within the sleeve 412. In some examples, the arm tip 404 can be configured to extend out of the sleeve 412 through an aperture 410 in an end of the support arm 402.

In some examples, the arm tip 404 extends out of the aperture 410 in response to a change in the orientation of the support arm 402 relative to a gravity vector G. Extension of the arm tip 404 can be partially or entirely gravity driven. In other words, the arm tip 404 can be configured to extend out of the support arm 402, at least partially in response to a change in the gravitational vector G relative to the support arm 402.

In some examples, the support arm 402 defines an interior volume or channel 412. The channel 412 can at least partially house the arm tip 404. The channel 412 can be sealed from the exterior environment. For example, the arm tip 404 can form a substantially airtight and/or liquid-tight seal with the interior walls of the support arm 402. The channel 412 can be serpentine or tortuous, having one or more turns. A sliding mass 415 and spring 417 can be located within the channel 412. A cross-sectional shape of the sliding mass 415 can be substantially similar to a portion of the channel 412 such that the sliding mass 415 forms a seal around the interior walls of the channel 412. Accordingly, as the mass 415 moves within the channel 412, the pressure within the channel 412 can be modulated.

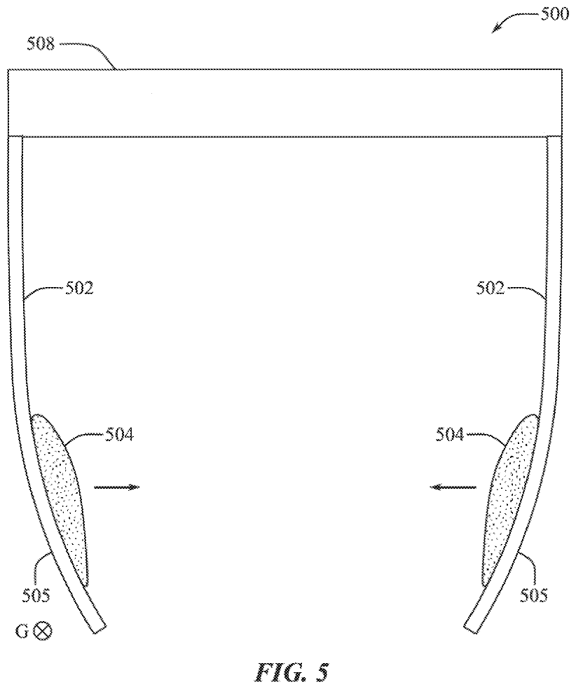

The sliding mass 415 can be positioned to translate a predetermined distance in response to the support arm 402 tilting downward. In other words, when the user looks down, gravity causes the sliding mass 415 to slide within the channel 412, which increases a pressure within the channel 412. The increased pressure within the channel 412 can push the arm tip 404 to out of the support arm 402 through the aperture 410. The spring 417 can bias the sliding mass 415 toward an end of the channel 412. In some examples, the sliding mass 415 and spring 417 are located at a first end of the channel, and the arm tip 404 is located at a second, opposite end of the channel 412. Further details of example adjustment mechanisms are provided below with reference to FIG. 5.

FIG. 5 shows a top view of computer glasses 500. The computer glasses 500 can be substantially similar to, including some or all of the features of, the computer glasses described herein. Support arms 502 can be substantially similar to, including some or all of the features of, the support arms described herein, such as support arms 102, 202, 302, 402, 502, 602, and 702. The support arms 502 can include adjustable arm tips 504. In some examples, one or more arm tips 504 includes a bladder 504 having a variable volume. The bladder 504 can contain liquid or gas used to increase a pressure within the bladder 504. In some examples, a movable actuator or cam can increase pressure within the bladder 504 causing it to expand outward toward the user's head. Likewise, an actuator can be manipulated to drop a pressure within or otherwise deflate the bladder 504. Modification of the bladder 504 can result from manual input by a user, or can result from automated electrical signals, valves and the like.

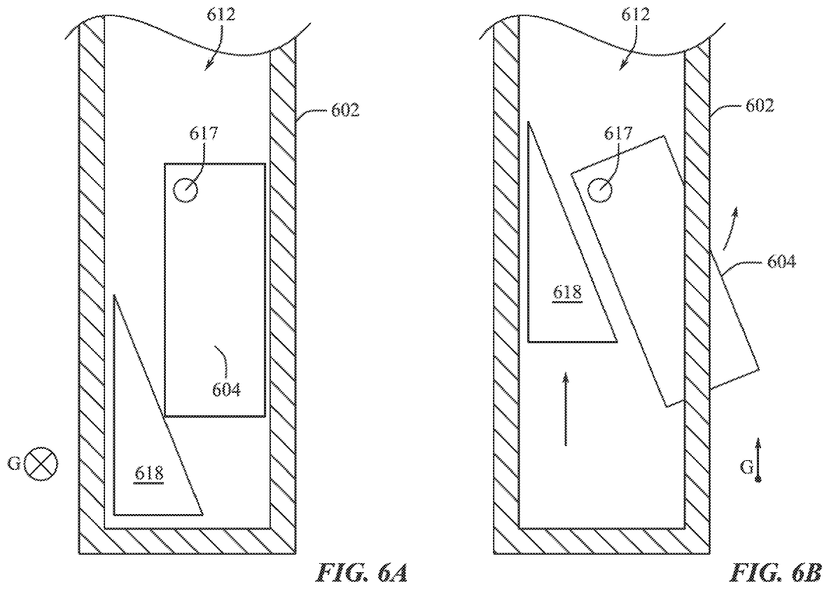

In some examples, the size of the bladder 504 increases in response to a determination by a processor that the computer glasses 500 are tilting downward or are at risk of slipping off a user's face. In some examples, the change in pressure within the bladder 504 is a result of the orientation of the computer glasses 500 changing relative to a gravitational vector G. Further details of example adjustment mechanisms are provided below with reference to FIGS. 6A and 6B.

FIG. 6A shows a cross-sectional top view of a support arm 602 in a retracted position, and FIG. 6B shows a cross-sectional top view of the support arm 602 in an extended position. The support arm 602 can be substantially similar to, including some or all of the features of, the support arms described herein, such as the support arm 102, 202, 302, 402, and 502.

The support arm 602 can include a free-floating translating cam 618 and an arm tip 604. The translating cam 618 can be configured to contact the arm tip 604. In some examples, the shape and/or path of the translating cam 618 can swing the arm tip 604 in a direction of the user's head. For example, the cam 618 can be allowed limited free motion in directions that are parallel with a gravitational vector G. Thus, when a user tilts their head downward, gravity can cause the cam 618 to fall into the arm tip 604. Because of the relative positioning and shapes of the cam 618 and arm tip 604, upon impact, the cam 618 rotates the arm tip 604 about a pivot point 617. In some examples, a spring or other biasing member can bias the arm tip 604 toward the retracted position.

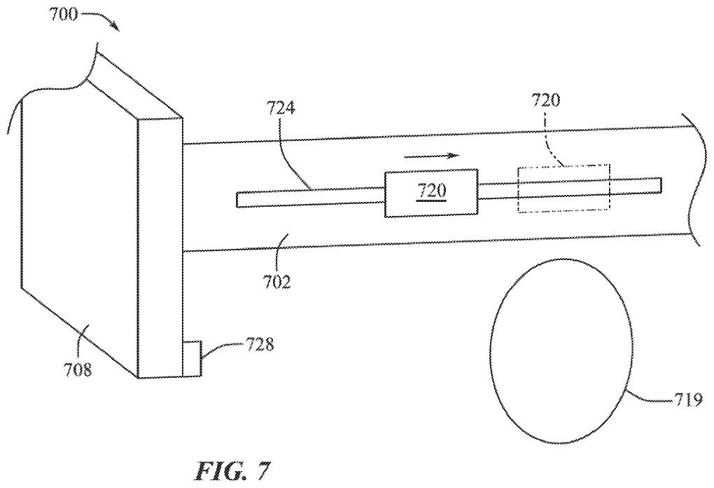

In some examples, the cam 618 can be actuated in response to a manual input by a user, or in response to electrical signals that are received and trigger a mechanical driving of the cam 618. Further details of example adjustment mechanisms are provided below with reference to FIG. 7.

FIG. 7 shows a perspective side view of a head-mounted device 700. The various components, features, and aspects of the device 700 shown in the example of FIG. 7 can be included in any of the devices described herein with reference to other figures. In addition, any of the components, features, and aspects of other devices described with reference to other figures can be included alone or in combination with the device 700 shown in FIG. 7.

The device 700 can include a speaker 720 that is connected to the securement mechanism 702 via a position adjusting mechanism 724 at unique locations on the securement mechanism 702, as shown. The position of the speaker 720 can be altered to adjust an orientation or location of the speaker 720 in order to enhance performance and user experience. For example, the position of the speaker 720 relative to an ear 719 of the user when the user dons the device 700 can affect the performance of the speaker and audio output thereby, including spatial audio perceptions. Before or after donning of the device 700, the position of the speaker 720, including its location along the securement mechanism 702 and its orientation or directionality, can be changed to place the speaker 720 in optimal locations along the securement mechanism 702 to produce optimal sound output to the user's ears while reducing the amount of sound lost to the outside environment.

In some examples, a sensor 728 is configured to determine an optimal location of the speaker 720 on the securement mechanism 702. For example, the sensor 728 can determine a relative location of the speaker 720 and the ear 719. Based on the detected relative positions, a processor can direct the speaker 720 to the ideal location (e.g., adjacent the ear 719). The sensor 728 can be located on the display unit 708 or on the securement mechanism 702. In some examples, sound from the speaker 720 itself is used as a guide for locating an ideal position. For example, the user can provide feedback of an audio signal emitted from the speaker 720, and based on that feedback, an optimal location of the speaker 720 can be determined.

The speaker 720 can move along the securement mechanism 702 according to any suitable methods and systems. For example, a cable and pulley assembly can reposition the speaker 720. In some examples, the position adjusting mechanism 724 can be a rail or track on which the speaker 720 is movably coupled. For example, the speaker 720 can include a motor having wheels or pulleys configured to translate along the position adjustment mechanism 724.

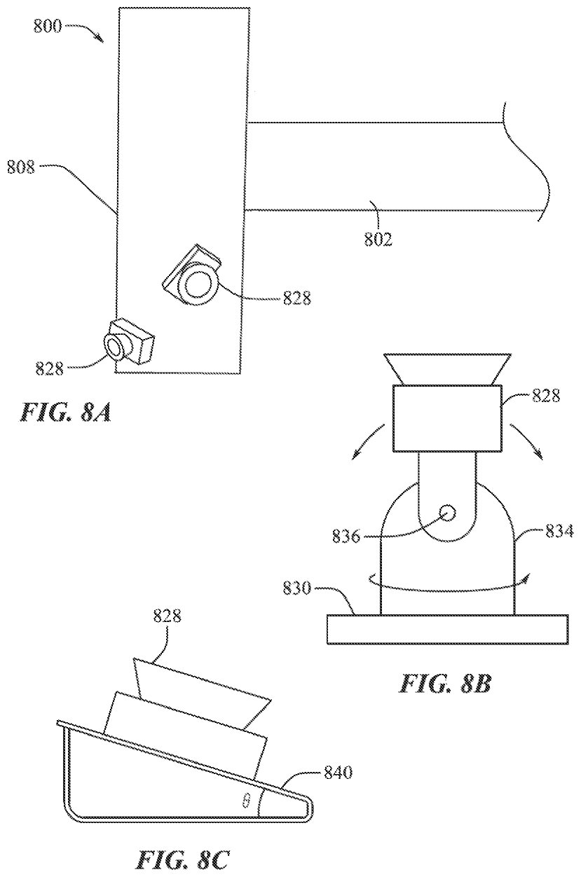

FIG. 8A shows a side view of an HMD 800. The HMD 800 can include optical sensors, such as cameras 828 that can be adjusted to adapt to inconsistent unique anatomical features of different users and variations associated with inconsistent donning. The cameras 828 can be adjusted depending on the general position, location, and orientation of the user, specifically the user's head, during use. In this way, the cameras 828 can be optimally configured for enhanced performance. In some examples, the cameras 828 can be automatically or manually adjusted or repositioned on a frame or display unit 808 of the HMD 800, at the appropriate position and/or in the appropriate orientation.

In some examples, the cameras 828 can be secured to the HMD 800 via one or more position adjusting mechanisms 834. In some examples, once the user has donned the HMD 800, the cameras 828 can be moved to reposition or reorient the components based on one or more user characteristics, such as head tilt.

The cameras 828 can provide feedback as the user manually adjusts the cameras to indicate when an optimal position or orientation has been achieved. Such feedback can be given visually through the display unit 808 or tactilely, audibly, or otherwise.

In examples where the adjustments are done automatically, the input of the cameras 828 can be used to determine where and how each camera 828 should be positioned based on a field of view of each camera 828. In some examples, a relative position of the camera 828 relative to the base 830 of the adjustment mechanism 834 or relative to the HMD 800 can be used to identify an optimal orientation of the camera 828.

As illustrated in FIG. 8B, the adjustment mechanism 834 can be movably connected to the camera 828 via a pivot point 836. The adjustment mechanism 834 can include one or more motors or actuators capable of changing a direction, position, and/or orientation of the camera 828. For example, an angle of the camera 828 relative to a base 830 can change by rotation of the camera 828 about the pivot point 836. In some examples, the camera 828 can be rotated via adjustment mechanism 834.

FIG. 8C shows a side view of a customized stand 840 for a camera 828. In some examples, the stand 840 can be a fixed component. The stand 840 can define an angle θ that dictates a gaze direction of the camera 828 once mounted to the HMD 800. The angle θ can be customized based on the user's natural head position.

The computer glasses described herein can be used in conjunction with a wide variety of computer based reality. For example, computer-generated reality (CGR) environment refers to a wholly or partially simulated environment that people sense and/or interact with via an electronic system. The glasses can be used in a mixed reality environment. In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). Further, an augmented virtuality (AV) environment refers to a simulated environment in which a virtual or computer generated environment incorporates one or more sensory inputs from the physical environment.

Personal information data, when gathered using authorized and well established secure privacy policies and practices, can be used with the various embodiments described herein. The disclosed technology remains operable without such personal information data.

It will be understood that the details of the present systems and methods above can be combined in various combinations and with alternative components. The scope of the present systems and methods will be further understood by the following claims.

What is claimed is:

1. A wearable electronic device, comprising:
a display;
a support arm attached to the display, the support arm defining a sleeve and comprising an extendable portion movable within the sleeve, the support arm having a retracted state and an extended state;
an inertial measurement unit (IMU) attached to the wearable electronic device; and
an actuator connected to the extendable portion;
wherein the actuator transitions the extendable portion from the retracted state to the extended state in response to a signal received by the actuator from the IMU.

2. The wearable electronic device of claim 1, wherein the support arm is a first support arm, the extendable portion is a first extendable portion, and the actuator is a first actuator;
the wearable electronic device further comprising a second support arm attached to the display, the second support arm comprising a second extendable portion, and a second actuator connected to the second extendible portion.

3. The wearable electronic device of claim 2, wherein a distance between the first extendable portion and the second extendable portion is greater in the retracted state than in the extended state.

4. The wearable electronic device of claim 1, wherein the IMU generates the signal in response to a detected motion.

5. The wearable electronic device of claim 1, wherein the actuator comprises a mechanical actuator engaged with the extendable portion.

6. The wearable electronic device of claim 1, wherein the extendable portion defines a radius of curvature in the extended state.

7. The wearable electronic device of claim 1, wherein:
the support arm defines a pressurized chamber adjacent to the extendible portion; and
the actuator causes the pressurized chamber to exert a force on the extendable portion in response to the signal.

8. The wearable electronic device of claim 1, wherein:
the extendable portion further comprises a mass portion; and
the extendable portion moves in response to a change in an orientation of the wearable electronic device relative to a gravitational vector.

9. The wearable electronic device of claim 1, further comprising a sensor configured to detect a removal of the wearable electronic device.

10. The wearable electronic device of claim 1, wherein:
a proximal end of the support arm is connected to the display; and
the extendable portion is located at a distal end of the support arm.

11. The wearable electronic device of claim 1, wherein the extendable portion is bi-stable.

12. The wearable electronic device of claim 1, further comprising a camera secured to the wearable device, the camera configured to determine a position of the wearable electronic device relative to a head of a user.

13. A support arm, comprising:
a static section;
a movable section connected to the static section, the movable section configured to dynamically vary a length of the support arm; and
an inertial measurement unit (IMU), the movable section extending in response to a signal from the IMU.

14. The support arm of claim 13, wherein the IMU is configured to generate the signal in response to detecting a motion of the support ar.

15. The support arm of claim 13, further comprising a mechanical actuator connected to the movable section.

16. The support arm of claim 13, further comprising an electrical actuator connected to the movable section.

17. The support arm of claim 13, wherein the static section defines an internal volume sized to receive the movable section.

18. A wearable electronic device, comprising:
a display; and
a support arm attached to the display, the support arm defining a sleeve and comprising an extendable portion movable within the sleeve, the support arm having a retracted state and an extended state;
wherein the support arm defines a pressurized chamber adjacent to the extendible portion; and
wherein the pressurized chamber exerts a force on the extendable portion in response to a detected motion.

19. The wearable electronic device of claim 18, further comprising:
a camera;
an actuator connected to the pressurized chamber; and
an inertial measurement unit (IMU) communicatively connected to the actuator;
wherein the IMU transmits a signal to the actuator when a motion is detected, the actuator causing the pressurized chamber to exert the force in response to the signal.

20. The wearable electronic device of claim 19, wherein the camera is configured to determine an orientation of the wearable electronic device relative to a head of a user.
